(19) United States
(12) Patent Application Publication
(10) Pub. No.: US 2018/0363727 A1
(43) Pub. Date: Dec. 20, 2018

(54) VIBRATION DAMPER WITH BLADE-TYPE ELASTIC MEMBER, AND METHOD FOR MAKING THE SAME

(71) Applicant: Valeo Embrayages, Amiens Cedex 2 (FR)

(72) Inventor: Patrick DURHAM, Troy, MI (US)

(21) Appl. No.: 15/624,051

(22) Filed: Jun. 15, 2017

(51) Int. Cl. F16F 15/133; F16H 45/02

(52) U.S. Cl. CPC F16F 15/1336; F16H 45/02; F16H 2045/0221; F16F 2226/04; F16F 2230/0064

(57) ABSTRACT

A torsional vibration damper includes a torque input member including a radially oriented first side plate and at least one supporting member mounted thereto, and a unitary radially resilient output member elastically coupled to the torque input member. The resilient output member includes at least one elastic blade configured to elastically and radially engage the at least one supporting member. The elastic blade has a raceway is configured to bear the at least one supporting member. The at least one elastic blade and a blade insert non-moveably secured to the main body. The blade insert radially engages the at least one supporting member. The raceway is defined by a radially outer surface of the blade insert.

### BACKGROUND OF THE INVENTION

### 1. Field of the Invention

The present invention generally relates to fluid coupling devices, and more particularly to a vibration damper for hydrokinetic torque-coupling devices, and a method for making the same.

### 2. Background of the Invention

A conventional hydrokinetic torque-coupling device 1 is schematically and partially illustrated in FIG. 1 and is configured to transmit torque from an output shaft of an internal combustion engine in a motor vehicle, such as for instance crankshaft 2a, to a transmission input shaft 2b. The conventional hydrokinetic torque-coupling device comprises a hydrokinetic torque converter 4 and a torsional vibration damper 5. The hydrokinetic torque converter conventionally comprises an impeller wheel 4i, a turbine wheel 4t, a stator (or reactor) 4s fixed to a casing of the torque converter 4, and a one-way clutch for restricting rotational direction of the stator 4s to one direction. The impeller wheel 4i is configured to hydrokinetically drive the turbine wheel 4t through the reactor 4s. The impeller wheel 4i is coupled to the crankshaft 1 and the turbine wheel 4t is coupled to a guide washer 6.

The torsional vibration damper 5 of the compression spring-type comprises a first group of coil springs 7a, 7b mounted between the guide washer 6 and an output hub 8 coupled to the transmission input shaft 2b. The coil springs 7a, 7b of the first group are arranged in series through a phasing member 9, so that the coil springs 7a, 7b are deformed in phase with each other, with the phasing member 9 being movable relative to the guide washer 6 and relative to the output hub 8. A second group of coil springs 7c is mounted with some clearance between the guide washer 6 and the output hub 8 in parallel with the first group of elastic members 7a, 7b, with the coil springs 7c configured to be active in a limited angular range, more particularly at the end of angular travel of the guide washer 6 relative to the output hub 8. The angular travel, or the angular shift α, of the guide washer 6 relative to the output hub 8, is defined relative to a rest position (α=0) wherein no torque is transmitted through damping means formed by the coil springs 7a, 7b. The second group of coil springs 7c makes it possible to increase the stiffness of the damping assembly at the end of angular travel, i.e. for a significant a angular offset of the guide washer 6 relative to the output hub 8 (or vice versa).

The torque-coupling device 1 further comprises a lock-up clutch 3 adapted to transmit torque from the crankshaft 2a to the guide washer 6 in a determined operation phase, without action from the impeller wheel 4i and the turbine wheel 4t.

The turbine wheel 4t is integrally or operatively connected with the output hub 8 linked in rotation to a driven shaft, which is itself linked to an input shaft of a transmission of a vehicle. The casing of the torque converter 4 generally includes a front cover and an impeller shell which together define a fluid-filled chamber. Impeller blades are fixed to an impeller shell within the fluid-filled chamber to define the impeller assembly. The turbine wheel 4t and the stator 4s are also disposed within the chamber, with both the turbine wheel 4t and the stator 4s being relatively rotatable with respect to the front cover and the impeller wheel 4i. The turbine wheel 4t includes a turbine shell with a plurality of turbine blades fixed to one side of the turbine shell facing the impeller blades of the impeller wheel 4i.

The turbine wheel 4t works together with the impeller wheel 4i, which is linked in rotation to the casing that is linked in rotation to a driving shaft driven by an internal combustion engine. The stator 4s is interposed axially between the turbine wheel 4t and the impeller wheel 4i, and is mounted so as to rotate on the driven shaft with the interposition of the one-way clutch.

While conventional hydrokinetic torque-coupling devices, including but not limited to those discussed above, have proven to be acceptable for vehicular driveline applications and conditions, improvements that may enhance their performance and cost are possible.

### BRIEF SUMMARY OF THE INVENTION

According to a first aspect of the invention, there is provided a torsional vibration damper. The torsional vibration damper comprises a torque input member rotatable about a rotational axis and including a radially oriented first side plate and at least one supporting member mounted thereto, and a unitary radially elastic output member pivotable relative to and elastically coupled to the torque input member. The radially elastic output member includes an output hub coaxial with the rotational axis and rotatable relative the torque input member, and at least one elastic blade integral with the output hub and configured to elastically and radially engage the at least one supporting member and to elastically bend in the radial direction upon rotation of the first side plate with respect to the radially elastic output member. At least one elastic blade defines a raceway configured to bear the at least one supporting member. The at least one elastic blade includes a main body and a blade insert non-moveably secured to the main body and radially engages the at least one supporting member. The raceway of the at least one elastic blade is defined by at least a portion of a surface of the blade insert.

According to a second aspect of the invention, there is provided a hydrokinetic torque-coupling device for coupling a driving shaft and a driven shaft together. The torque-coupling device comprises a casing rotatable about a rotational axis and having a locking surface, a torque converter including an impeller wheel rotatable about the rotational axis and a turbine wheel disposed in the casing coaxially with the rotational axis, and a locking piston axially moveable along the rotational axis to and from the locking surface of the casing. The turbine wheel is disposed axially opposite to the impeller wheel and hydro-dynamically rotationally drivable by the impeller wheel. The locking piston has an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing. The locking piston including a torsional vibration damper comprises a torque input member including a radially oriented first side plate and at least one supporting member mounted thereto, and a unitary radially elastic output member pivotable relative to and elastically coupled to the torque input member. The radially elastic output member includes an output hub coaxial with the rotational axis and rotatable relative the torque input member, and at least one elastic blade integral with the output hub and configured to elastically and radially engage the at least one supporting member and to elastically bend in the radial direction upon rotation of the first side plate with respect to the radially elastic output member. The at least one elastic blade defines a raceway configured to bear the at least one supporting member. The at least one elastic blade includes a main body made and a blade insert non-moveably secured to the main body of the at least one elastic blade and radially engaging the at least one supporting member. The raceway of the at least one elastic blade is defined by a surface of the blade insert.

According to a third aspect of the invention, there is provided a radially elastic output member for a torsional vibration damper. The radially elastic output member is rotatable about a rotational axis, and comprises an output hub rotatable relative the rotational axis and two elastic blades extending from the output hub. Each of the elastic blades is integral with the output hub. At least a portion of a surface of each blade insert defines a raceway.

According to a fourth aspect of the present invention, there is provided a method for assembling a torsional vibration damper. The method involves the steps of providing a radially oriented first side plate and at least one supporting member, rotatably mounting the at least one supporting member to the first side plate, providing a unitary radially elastic output member, which includes an output hub coaxial with the rotational axis and rotatable relative the torque input member, and at least one elastic blade integral with the output hub and configured to elastically and radially engage the at least one supporting member and to elastically bend in the radial direction upon rotation of the first side plate with respect to the radially elastic output member, and elastically coupling the elastic output member to the torque input member so that the at least one elastic blade elastically and radially engages the at least one supporting member. The at least one elastic blade defines a raceway configured to bear the at least one supporting member. The at least one elastic blade includes a main body and a blade insert non-moveably secured to the main body and radially engaging the at least one supporting member.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a schematic representation of a torque-coupling device of the prior art;

FIG. 2 is a fragmented half-view in axial section of a hydrokinetic torque-coupling device with a torsional vibration damper in accordance with an exemplary embodiment of the present invention;

FIG. 3 is fragmented partial half-view in axial section of the hydrokinetic torque-coupling device of FIG. 2 showing the torsional vibration damper and a locking piston in accordance with the exemplary embodiment of the present invention;

FIG. 4A is a perspective view of a torque input member of the torsional vibration damper in accordance with the exemplary embodiment of the present invention from one side;

FIG. 4B is a perspective view of the torque input member of the torsional vibration damper in accordance with the exemplary embodiment of the present invention from another side;

FIG. 5 is a partial perspective view of the torque input member and a radially elastic output member of the torsional vibration damper in accordance with the exemplary embodiment of the present invention;

FIG. 6 is an exploded assembly view in perspective of the torsional vibration damper in accordance with the exemplary embodiment of the present invention;

FIG. 7 is an elevational view of an integral radially elastic output member according to a first exemplary embodiment thereof;

FIG. 8 is an elevational view of an integral radially elastic output member according to a second exemplary embodiment thereof;

FIG. 9 is a fragmented cross-sectional view of the integral radially elastic output member in accordance with the second exemplary embodiment thereof taken along the line 9-9 in FIG. 8;

FIG. 10 is an elevational view of an integral radially elastic output member according to a third exemplary embodiment thereof;

FIG. 11 is an elevational view of an integral radially elastic output member according to a fourth exemplary embodiment thereof;

FIG. 12 is a perspective view of a turbine shell in accordance with the exemplary embodiment of the present invention;

FIG. 13 is a perspective view of the torsional vibration damper and the turbine shell drivingly engaged by the torsional vibration damper in accordance with the exemplary embodiment of the present invention; and

FIG. 14 is an elevational view of the turbine shell drivingly engaged by the torsional vibration damper in accordance with the exemplary embodiment of the present invention.

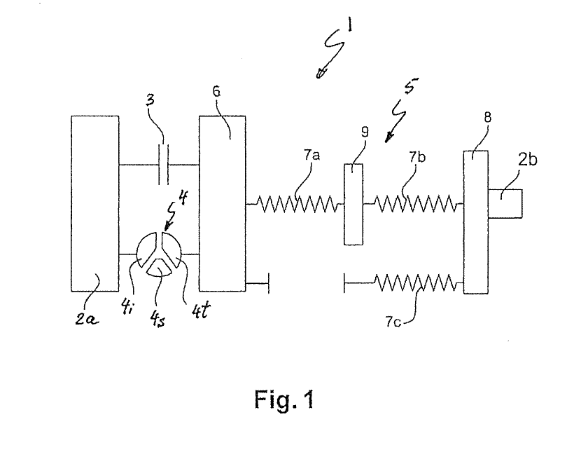

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” and “an” as used in the claims means “at least one” and the word “two” as used in the claims means “at least two”.

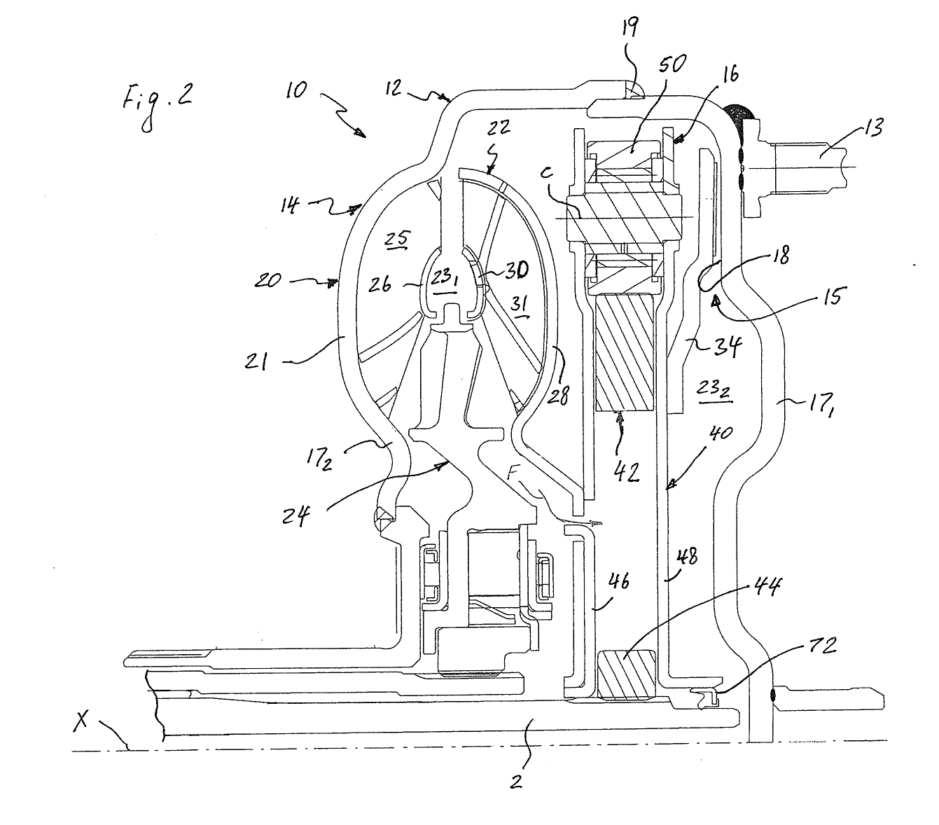

A first exemplary embodiment of a hydrokinetic torque-coupling device is generally represented in FIG. 2 by reference numeral 10. The hydrokinetic torque-coupling device 10 is intended to couple a driving shaft and a driven shaft 2, for example of a motor vehicle. In this case, the driving shaft is an output shaft of an internal combustion engine (ICE) of the motor vehicle and the driven shaft 2 is a transmission input shaft of an automatic transmission of the motor vehicle.

The hydrokinetic torque-coupling device 10 comprises a sealed casing 12 filled with a fluid, such as oil or transmission fluid, and rotatable about a rotational axis X of rotation, a hydrokinetic torque converter 14 disposed in the casing 12, a lock-up clutch 15 and a torque-transmitting device (or torsional vibration damper) 16 also disposed in the casing 12. The torsional vibration damper 16 of the present invention is in the form of a leaf (or blade) damper. The sealed casing 12, the torque converter 14, the lock-up clutch 15 and the torsional vibration damper 16 are all rotatable about the rotational axis X. The drawings discussed herein show half-views, that is, a cross-section of the portion or fragment of the hydrokinetic torque-coupling device 10 above the rotational axis X. As is known in the art, the torque-coupling device 10 is symmetrical about the rotational axis X. Hereinafter the axial and radial orientations are considered with respect to the rotational axis X of the torque-coupling device 10. The relative terms such as “axially,” “radially,” and “circumferentially” are with respect to orientations parallel to, perpendicular to, and circularly around the rotational axis X, respectively.

The sealed casing 12 according to the first exemplary embodiment as illustrated in FIG. 2 includes a first shell (or cover shell) 17₁, and a second shell (or impeller shell) 17₂ disposed coaxially with and axially opposite to the first shell 17₁. The first and second shells 17₁, 17₂ are non-movably (i.e., fixedly) interconnected and sealed together about their outer peripheries, such as by weld 19. The first shell 17₁ is non-movably (i.e., fixedly) connected to the driving shaft, more typically to the output shaft of the ICE through a flexplate that is non-rotatably fixed to the driving shaft, so that the casing 12 turns at the same speed at which the engine operates for transmitting torque. Specifically, in the illustrated embodiment of FIG. 2, the casing 12 is rotatably driven by the ICE and is non-rotatably coupled to the driving shaft thereof, such as with studs 13 through the flexplate. Typically, the studs 13 are fixedly secured, such as by welding, to the first shell 17₁. Each of the first and second shells 17₁, 17₂ are integral or one-piece and may be made, for example, by press-forming one-piece metal sheets.

The torque converter 14 comprises an impeller wheel (sometimes referred to as the pump, impeller assembly or impeller) 20, a turbine wheel (sometimes referred to as the turbine assembly or turbine) 22, and a stator (sometimes referred to as the reactor) 24 interposed axially between the impeller wheel 20 and the turbine wheel 22. The impeller wheel 20, the turbine wheel 22, and the stator 24 are coaxially aligned with one another and the rotational axis X. The impeller wheel 20, the turbine wheel 22, and the stator 24 collectively form a torus. The impeller wheel 20 and the turbine wheel 22 may be fluidly coupled to one another in operation as known in the art. In other words, the turbine wheel 22 is hydro-dynamically drivable by the turbine wheel 22.

The impeller wheel 20 includes a substantially annular, semi-toroidal (or concave) impeller shell 21, a substantially annular impeller core ring 26, and a plurality of impeller blades 25 fixedly (i.e., non-moveably) attached, such as by brazing, to the impeller shell 21 and the impeller core ring 26. Thus, at least a portion of the second shell 17₂ of the casing 12 also forms and serves as the impeller shell 21 of the impeller wheel 20. Accordingly, the impeller shell 21 sometimes is referred to as part of the casing 12. The impeller wheel 20, including the impeller shell 21 (the part of the casing 12), the impeller core ring 26 and the impeller blades 25, are non-rotatably secured to the driving shaft (or flywheel) of the engine to rotate at the same speed as the engine output. The impeller shell 21, impeller core ring 26 and the impeller blades 25 are conventionally formed by stamping from steel blanks.

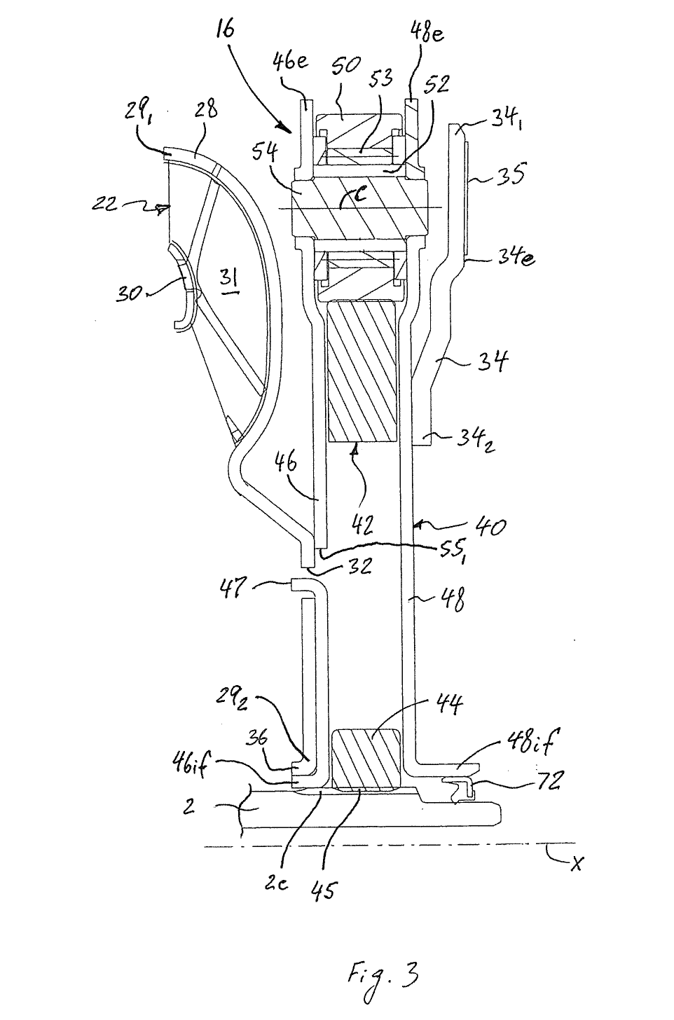

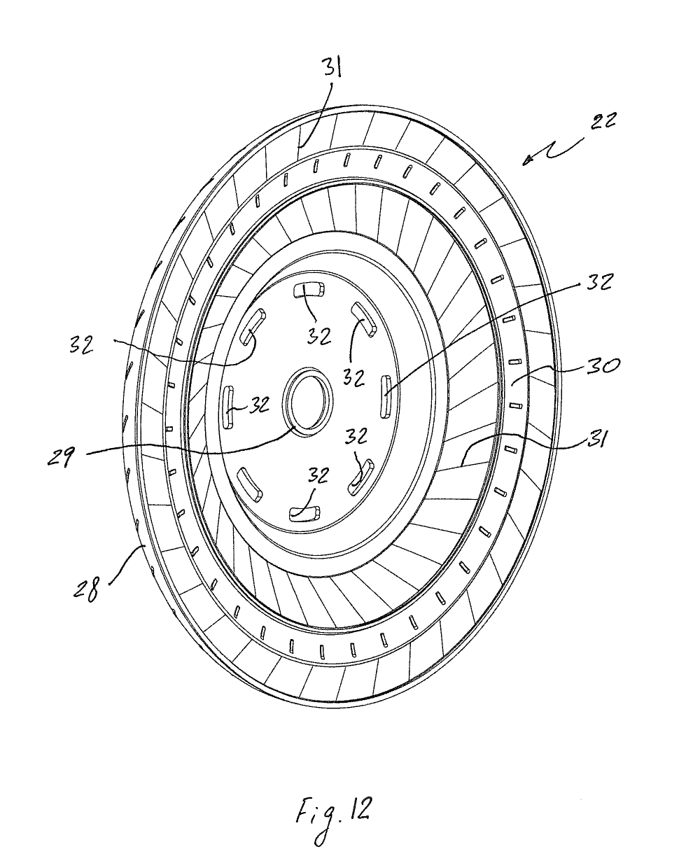

The turbine wheel 22, as best shown in FIG. 2, comprises a substantially annular, semi-toroidal (or concave) turbine shell 28 rotatable about the rotational axis X, a substantially annular turbine core ring 30, and a plurality of turbine blades 31 fixedly (i.e., non-moveably) attached, such as by brazing, to the turbine shell 28 and the turbine core ring 30. The turbine shell 28 of the turbine wheel 22 is formed with at least one, and preferably a plurality of coupling openings 32 therethrough and circumferentially and equiangularly spaced from each other around the rotational axis X, as best shown in FIGS. 3 and 12. The turbine shell 28, the turbine core ring 30 and the turbine blades 31 are conventionally formed by stamping from steel blanks. Extending axially outwardly at a radially inner peripheral end 29, of the turbine shell 28 is a generally cylindrical, radially inner flange 36. The cylindrical flange 36 of the turbine wheel 22 is rotatable relative to the driven shaft 2.

The impeller shell 21 and the turbine-piston shell 28 collectively define a substantially toroidal first chamber (or torus chamber) 23₁ therebetween. Referring to FIG. 2, the torus chamber 23₁ is to the left side of the turbine-piston shell 28, and a second (or damper) chamber 23₂ is to the other (right) side of the turbine-piston shell 28. In other words, the first chamber 23₁ is defined between the impeller shell 21 and the turbine-piston shell 28, while the second chamber 23₂ is defined between torsional vibration damper 16 and the first shell 17₁. The cover shell 17₁ of the casing 12 defines a locking surface 18.

The lock-up clutch 15 includes a locking piston axially moveable along the rotational axis X to and from the locking surface 18 so as to selectively non-rotatably engage the turbine wheel 22 and the casing 12. In turn, the locking piston includes the torsional vibration damper 16 and a substantially annular piston member 34 non-moveably connected (i.e., fixed) to the torsional vibration damper 16. Thus, the torsional vibration damper 16 together with the piston member 34 defines the locking piston of the lock-up clutch 15.

The piston member 34 has an engagement surface 34e facing the locking surface 18. The piston member 34 is axially moveable along the rotational axis X to and from the locking surface 18 so as to selectively engage the locking surface 18 of the casing 12. The lock-up clutch 15 further includes an annular friction liner 35 fixedly attached to the engagement surface 34e of the piston member 34 by appropriate means known in the art, such as by adhesive bonding. As best shown in FIGS. 2 and 3, the friction liner 35 is fixedly attached to the engagement surface 34e of the piston member 34 at a radially outer peripheral end 34, thereof.

The annular friction liner 35 is made of a friction material for improved frictional performance. Alternatively, an annular friction liner may be secured to the locking surface 18 of the casing 12. According to still another embodiment, a first friction ring or liner is secured to the locking surface 18 of the casing 12 and a second friction ring or liner is secured to the engagement surface 34e of the piston member 34. It is within the scope of the invention to omit one or both of the friction rings. In other words, the annular friction liner 35 may be secured to any, all, or none of the engagement surfaces. Further according to the exemplary embodiment, the engagement surface 34e of the piston member 34 is slightly conical to improve the engagement with the lock-up clutch 15. Specifically, the engagement surface 34e of the piston member 34 holding the annular friction liner 35 is conical, at an angle of between 10° and 30° relative to the engagement surface 34e of the piston member 34 (or to the plane orthogonal to the rotational axis X), to improve the torque capacity of the lock-up clutch 15. Alternatively, the engagement surface 34e of the piston member 34 may be parallel to the locking surface 18 of the casing 12.

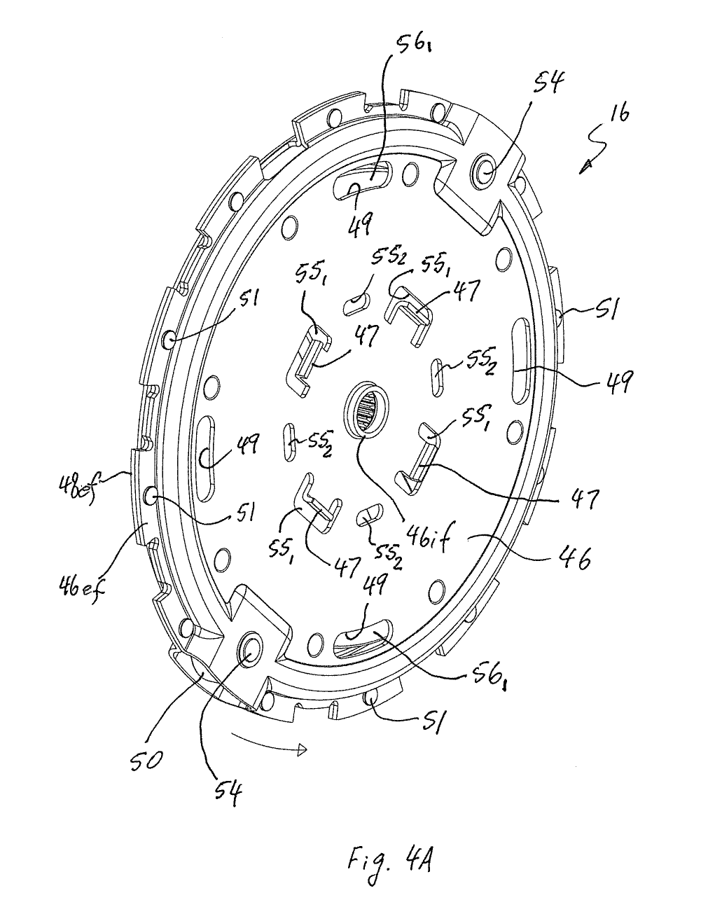

The torsional vibration damper 16, as best shown in FIGS. 4A and 4B, advantageously allows the turbine wheel 22 of the torque converter 14 to be coupled, with torque damping, to the driven shaft 2, i.e., the input shaft of the automatic transmission. The torsional vibration damper 16 also allows damping of stresses between the driving shaft and the driven shaft 2 that are coaxial with the rotational axis X, with torsion damping.

The torsional vibration damper 16, as best shown in FIG. 2, is disposed axially between the turbine shell 28 of the turbine assembly 22, and the cover shell 17₁ of the casing 12. The piston member 34 of the lock-up clutch 15 is non-movably (i.e., fixedly) secured to the torsional vibration damper 16. Moreover, the piston member 34 and the torsional vibration damper 16 are non-rotatably and axially slidably mounted to the driven shaft 2. The torsional vibration damper 16 with the piston member 34 is positioned on the driven shaft 2 in a limited, movable and centered manner. The piston member 34 forms an input part of the torsional vibration damper 16.

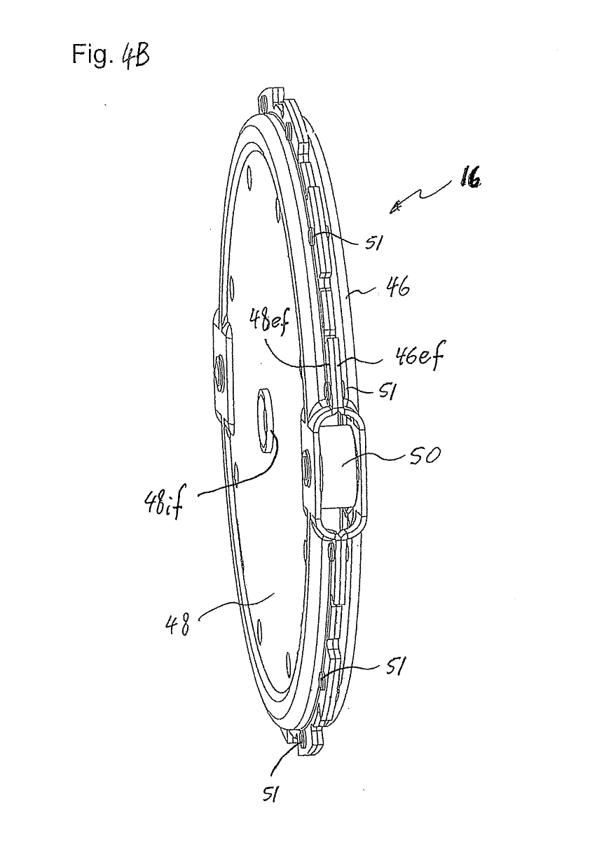

The torsional vibration damper 16 comprises a torque input member 40 rotatable about the rotational axis X, and an integral radially elastic output member 42₁ according to a first exemplary embodiment thereof. The integral radially elastic output member 42₁ is elastically coupled to and configured to pivot (i.e., rotate) relative to the torque input member 40 around the rotational axis X, as best shown in FIGS. 3 and 5.

The torque input member 40 includes two axially opposite annular, radially oriented retainer plates, including a first annular, radially oriented side plate 46 adjacent to the turbine shell 28, and a second annular, radially oriented side plate 48 adjacent to the piston member 34 and the cover shell 17₁. The first side plate 46 is substantially parallel to and axially spaced from the second side plate 48, as best shown in FIG. 3. Moreover, the first and second side plates 46 and 48, respectively, are non-moveably attached (i.e., fixed) to one another, such as by mechanical fasteners (such as rivets) 51, as best shown in FIGS. 4 and 5.

According to the exemplary embodiment of the present invention, as best illustrated in FIGS. 2-6, 13 and 14, a radially distal end 46e of the first side plate 46 has a substantially annular outer (or external) flange 46ef provided with a plurality of circumferentially spaced holes. A radially distal end 48e of the second side plate 48, on the other hand, has a substantially annular outer (or external) flange 48ef provided with a plurality of circumferentially spaced holes. The first and second side plates 46 and 48 are non-movably (i.e., fixedly) secured to one another so that the outer mounting flanges 46ef, 48ef of the first and second side plates 46, 48 axially engage one another and are fixed by the rivets 51 extending through the holes in the outer mounting flanges 46ef, 48ef of the first and second damper side plates 46, 48, as best shown in FIGS. 4 and 5. Thus, the first and second side plates 46, 48 are non-rotatable relative to one another, but rotatable relative to the radially elastic output member 42₁.

Extending axially outwardly at a radially inner peripheral end of the first side plate 46 is a substantially cylindrical, radially inner flange 46if, as best shown in FIG. 4A. The first side plate 46 with the cylindrical flange 46if is rotatable relative to the driven shaft 2. The cylindrical flange 36 of the turbine wheel 22 is mounted onto the cylindrical flange 46if of the first side plate 46 of the torque input member 40 of the torsional vibration damper 16, as best shown in FIG. 3. As discussed in further detail below, the first side plate 46 of the torque input member 40 of the torsional vibration damper 16 is axially movable relative to the turbine wheel 22 and the driven shaft 2 along this interface. The turbine wheel 22 is not axially movable relative to the driven shaft 2 along the rotational axis X.

Extending axially outwardly at a radially inner peripheral end of the second side plate 48 is a generally cylindrical, radially inner flange 48if, as best shown in FIG. 4B. The second side plate 48 with the cylindrical flange 48if is rotatable relative to the driven shaft 2. A sealing member 72, mounted to the cylindrical flange 48if of the second side plate 48 of the torque input member 40, creates a seal at the interface of the second side plate 48 and the driven shaft 2, as best shown in FIG. 3. As discussed in further detail below, the torque input member 40 of the torsional vibration damper 16 is axially movably relative to the driven shaft 2 along this interface.

As further illustrated in FIGS. 2 and 3, the piston member 34 is non-moveably attached (i.e., fixed) to the second side plate 48 of the torque input member 40 of the torsional vibration damper 16, such as by weld or by fasteners, e.g., rivets. Those skilled in the art should understand that the term “non-moveably connected” (or “non-moveably attached”) means a piston member 34 or other assembly made of separate components fixedly (i.e., non-moveably) connected together, such as by rivets, weldment, adhesives, or the like, or a part made as a single-piece component (i.e., made as a single-piece part), such as by casting, forging, press forming, or the like. The first and second side plates 46, 48 are arranged axially on either side of the elastic output member 42₁, and are operatively connected therewith. The first and second side plates 46, 48 are non-movably (i.e., fixedly) secured to one another by appropriate means, such as by the rivets 51 (best shown in FIGS. 4A and 4B) so as to rotatable relative to the elastic output member 42₁.

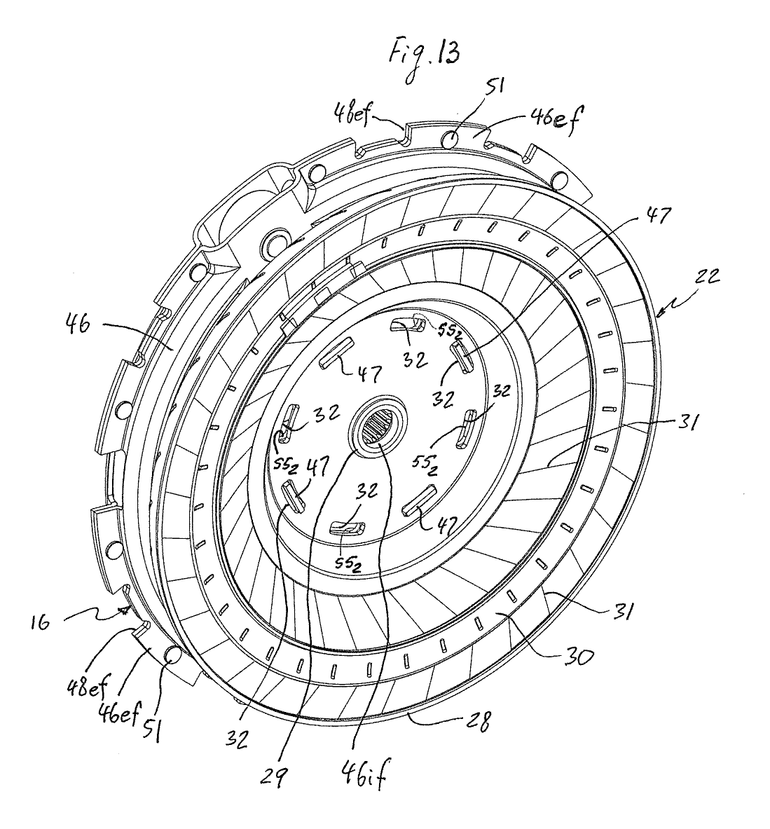

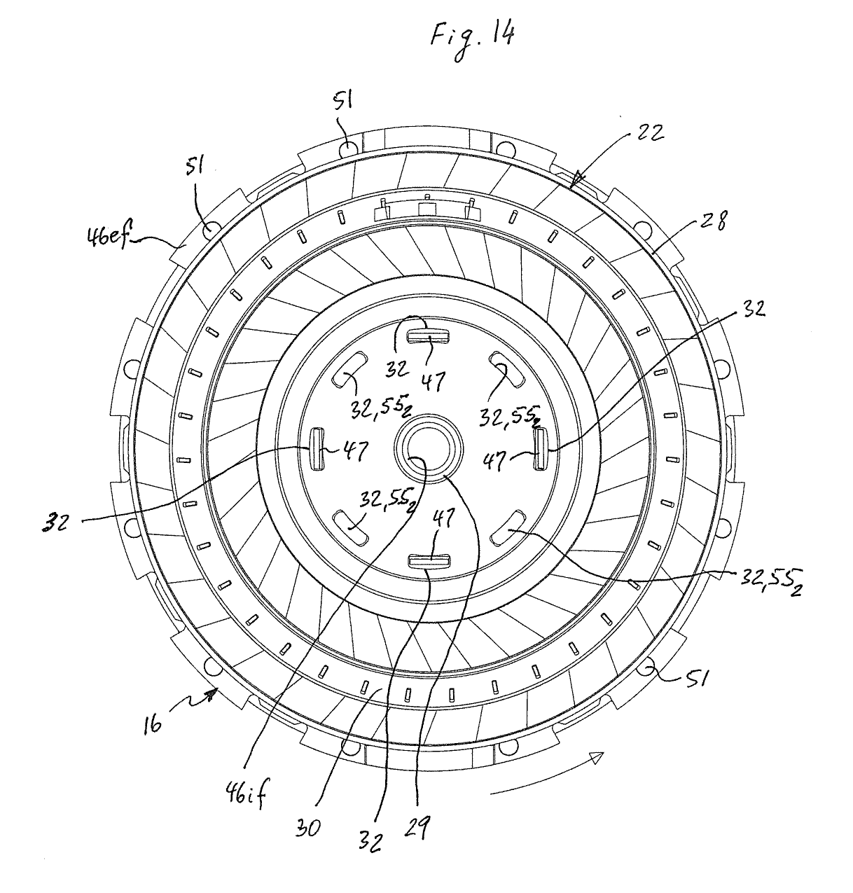

Moreover, as best shown in FIGS. 3, 4A and 6, the radially oriented first side plate 46 includes at least one, preferably a plurality of coupling arms 47 axially extending therefrom toward the turbine shell 28 of the turbine wheel 22 and defining a corresponding plurality of first communication openings 55₁ each adjacent to one of the coupling arms 47. The coupling arms 47 and the first communication openings 55₁ are circumferentially and equiangularly spaced from each other around the rotational axis X. The first side plate 46 with the axially extending coupling arms 47 is an integral (or unitary) part, i.e., made of a single component (i.e., made as a single part), or a part made of separate components fixedly connected together. Each of the coupling arms 47 and each of the first communication openings 55₁ of the first side plate 46 are complementary to and registered (i.e., radially and angularly aligned) with one of the coupling openings 32 through the turbine shell 28 of the turbine wheel 22, as best shown in FIGS. 13 and 14.

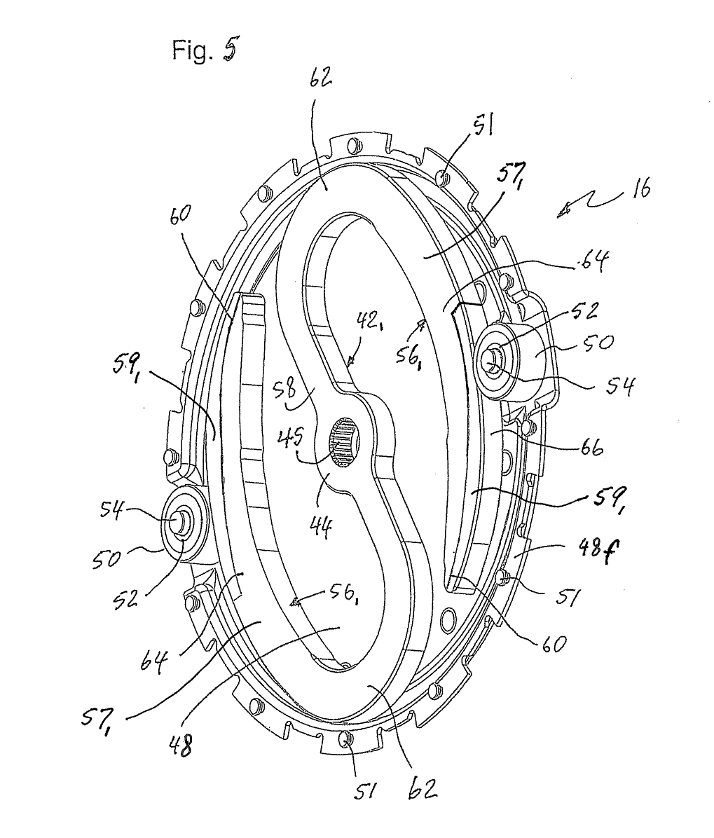

In addition, the radially oriented first side plate 46 is formed with at least one, and preferably a plurality of second communication openings 55₂ therethrough and circumferentially spaced from each other around the rotational axis X, as best shown in FIGS. 4A and 6. As further illustrated in FIGS. 4A and 6, the second communication openings 55₂ are angularly spaced from the first communication openings 55₁. Each of the second communication openings 55₂ through the first side plate 46 is complementary to and registered with another one of the coupling openings 32 through the turbine shell 28 of the turbine wheel 22, i.e., the coupling openings 32 not receiving the coupling arms 47 therethrough, as best shown in FIGS. 13 and 14.

Thus, the first and second communication openings 55₁ and 55₂ through the first side plate 46 of the torque input member 40 of the torsional vibration damper 16 and the coupling openings 32 through the turbine shell 28 provide fluid communication between the torus and the damper pressure chambers 23₁ and 23₂, respectively. The first side plate 46 with the coupling arms 47 and the first and second communication openings 55₁ and 55₂ are preferably formed by stamping from a steel blank.

In an assembled condition of the hydrokinetic torque-coupling device 10, one or more of the coupling arms 47 of the first side plate 46 drivingly engage the turbine shell 28 by axially extending through one or more of the coupling openings 32 in the turbine shell 28 of the turbine wheel 22, as best shown in FIGS. 3, 13 and 14. Accordingly, the turbine shell 28 of the turbine wheel 22 and the first side plate 46 of the torsional vibration damper 16 are non-rotatably coupled to one another. The turbine wheel 22 and the torque input member 40 of the torsional vibration damper 16 are thus non-rotatably coupled to one another. Moreover, each of the coupling arms 47 positively engages one of the coupling openings 32 so as to non-rotatably couple the turbine wheel 22 and the torque input member 40 of the torsional vibration damper 16, while allowing axial motion of the torsional vibration damper 16 with respect to the turbine wheel 22, as best shown in FIGS. 2 and 3. Accordingly, the torque input member 40 and the piston member 34 are non-rotatably coupled to and axially moveable relative to the turbine shell 28 of the turbine wheel 22.

According to the exemplary embodiment of the present invention, the first side plate 46 includes four (4) coupling arms with four (4) first communication openings 55₁, and four (4) second communication openings 55₂, while the turbine shell 28 of the turbine wheel 22 has eight (8) coupling openings 32. In other words, not each of the coupling openings 32 through the turbine shell 28 of the turbine wheel 22 receives one of the coupling arms 47 therethrough. The coupling openings 32 not engaged by the coupling arms 47 and the second communication openings 55₂ provide free hydraulic fluid flow through the first side plate 46 into a cavity axially between the first and second side plates 46 and 48 of the torsional vibration damper 16. Smaller amounts of the hydraulic fluid flow through the rest of the coupling openings 32 and the first communication openings 55₁.

The torque input member 40 further includes at least one, and preferably two supporting members 50. In the exemplary embodiment, the supporting members 50 are in the form of annular rolling bodies (or cam followers), such as cylindrical rollers rotatably mounted to the radially external peripheries of the first retainer plate 46 and the second side plates 48, and axially disposed between the first and second side plates 46 and 48, respectively. Each of the rolling bodies 50 is rotatable around a central axis C thereof best shown in FIGS. 2 and 3. The central axis C of the rolling body 50 is substantially parallel to the rotational axis X, as best shown in FIGS. 2 and 3.

The rolling bodies 50 are positioned so as to be diametrically opposite one another, as best shown in FIG. 5. More specifically, the rolling bodies 50 are rotatably mounted about cylindrical shafts 52, which axially extend between the first and second side plates 46 and 48. The cylindrical shafts 52 have a hollow interior and are mounted on the first and second side plates 46 and 48 through support pins 54 extending through the hollow interiors of the cylindrical shafts 52 and the first and second side plates 46 and 48, as best shown in FIGS. 3 and 4. The rolling bodies 50 are rotatably mounted on the cylindrical shafts 52 through rolling bearings, such as needle bearings 53, for instance, best shown in FIGS. 3 and 5.

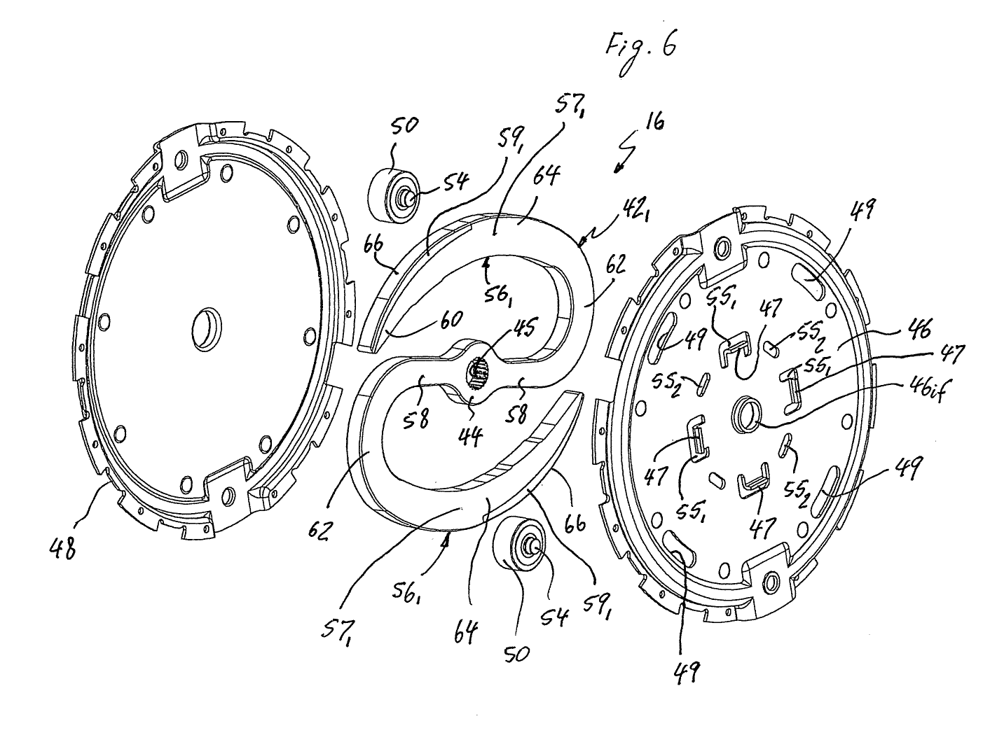

The radially elastic output member 42₁, includes an annular output hub 44 coaxial with the rotational axis X and rotatable relative to the torque input member 40, and at least one and preferably two substantially identical, radially opposite curved elastic leaves (or blades) 56₁ integral (or unitary) with (i.e., made as a single part or as a part made of separate components fixedly (i.e., non-moveably) connected together) the output hub 44, as best shown in FIGS. 5-7. A radially inner annular surface of the output hub 44 includes radially inner splines 45 for directly and non-rotatably engaging complementary radially outer splines 2c of the driven shaft 2. At the same time, the output hub 44 of the radially elastic output member 42₁ is axially moveable relative to the driven shaft 2 due to a splined connection therebetween. Accordingly, the radially elastic output member 42₁, is non-rotatably coupled to and axially moveable relative to the driven shaft 2.

As best shown in FIG. 6, the curved elastic leaves 56₁ are symmetrical with respect to the rotational axis X. Moreover, each of the curved elastic leaves 56₁ has a proximal end 58 non-moveably connected (i.e., fixed) to the output hub 44, a free, angularly distal end 60, a bent portion 62 adjacent to the proximal end 58, and a curved raceway portion 64 defining a cam profile and disposed adjacent to the free distal end 60 of the elastic leaf 56₁ for bearing one of the rolling bodies 50. Also, the curved raceway portion 64 is connected to the output hub 44 by the bent portion 62. The output member 42₁ with the output hub 44 and the elastic leaves 56₁ is preferably an integral (or unitary) component, i.e. a single part or a part made of separate components fixedly (i.e., non-moveably) connected together.

Each of the curved elastic leaves 56₁ and each of the raceway portions 64 are elastically deformable in radial direction. The bent portion 62 subtends an angle of approximately 180°. At least a portion of a radially external surface of the curved raceway portion 64 of each of the curved elastic leaves 56₁ defines a radially outer raceway 66 configured as a surface that is in rolling contact with one of the rollers 50, so that each of the rolling bodies 50 is positioned radially outside of the elastic leaf 56₁, as illustrated in FIGS. 2, 3 and 5. The raceways 66 of the curved raceway portions 64 of the curved elastic leaf 56₁ extend on a circumference and subtend an angle ranging from about 90° to about 180°. The raceway 66 of each of the curved raceway portions 64 has a generally convex shape, as best shown in FIGS. 5-7. Moreover, as the torque input member 40 is axially moveable along the rotational axis X relative to the turbine assembly 22 and the turbine assembly 22, the rolling bodies 50 are axially displaceable relative to the raceways 66 of the curved raceway portions 64 of the curved elastic leaves 56₁.

As described above, the radially elastic output member 42₁ is configured to be elastically and radially supported by the rolling bodies 50, and to elastically bend in the radial direction upon rotation of the torque input member 40 with respect to the radially elastic output member 42₁, as best shown in FIGS. 3 and 5. Thus, each of the elastic blades 56₁ is a flexible member. Each radially elastic blade 56₁ is deformed by a rolling bodies 50 contacting a portion of the associated radially elastic blade 56₁. Thus, material of the elastic blades 56₁ has to be flexible (i.e., elastic). On the other hand, the forces of the rolling bodies 50 contacting a portion of the elastic blades 56₁ are significant.

As best shown in FIGS. 5-7, each of the curved elastic leaves 56₁ is symmetrical with respect to the rotational axis X. Moreover, each of the curved elastic leaves 56₁ of the radially elastic output member 42₁ includes a main body 57₁ and a blade insert 59₁ non-moveably secured (i.e., fixed) to the main body 57₁ of each of the curved elastic leaves 56₁. The blade insert 59₁ is formed separate from the main body 57₁ and is fixed to the main body 57₁ of each of the curved elastic leaves 56₁ by appropriate means, such as mechanical fasteners (e.g., rivets or screws), welding (such as laser welding), adhesive bonding, etc.

The main body 57₁ of each of the curved elastic blades 56₁ is made of highly resilient (i.e., elastic) material, such as spring steel, carbon fiber or composite polymer material. The blade insert 59₁ of each of the curved elastic blades 56₁, on the other hand, is made of hardened steel, such as tool steel (HRC 45-65), and includes the curved raceway portion 64 defining the cam profile. The term “tool steel” commonly refers to a variety of carbon and alloy steels that are particularly well-suited to be made into tools, such as cutting tools. Their suitability comes from their distinctive hardness, resistance to abrasion and deformation and their ability to hold a cutting edge at elevated temperatures. As a result, tool steels are suited for their use in the shaping of other materials. Thus, the main body 57₁ and the blade insert 59₁ of the at least one elastic blades 56₁ are made of materials having different chemical composition and mechanical properties. Specifically, the main body 57₁ is made of a first material, and the blade insert 59₁ is made of a second material, which is different from the first material. In other words, the first and second materials have different chemical composition and mechanical properties. Moreover, the first material of the main body 57₁ has greater elasticity (resiliency) than the second material of the blade insert 59₁, while the second material of the blade insert 59₁ has higher hardness than the first material of the main body 57₁.

The radially outer raceway 66 of each of the curved elastic blades 56₁ is defined by at least a portion of a radially outer surface of the blade insert 59₁ (made of hardened steel) that is in rolling contact with an associated one of the rollers 50. Preferably, the radially outer raceway 66 of each of the curved elastic blades 56₁ is defined only by the radially outer surface of the blade insert 59₁ that is in rolling contact with the associated one of the rollers 50. Thus, the rollers 50 travel on the blade insert 59₁ and do not make contact with the main body 57₁ of the curved elastic blade 56₁. As best shown in FIGS. 5-7, the blade insert 59₁ is in the form of a curved steel strip fixed to a groove (or depression) 65, in the main body 57₁ of the curved elastic leaves 56₁. Furthermore, the radially outer raceway 66 of the blade insert 59₁ is coplanar with a radially outer surface 61₁ of the main body 57₁ adjacent to the radially outer raceway 66 of the curved elastic blade 56₁. Moreover, the main body 57₁ of the curved elastic leaves 56₁ overlaps an entire length of the blade insert 59₁ in circumferential direction, as further shown in FIGS. 5-7. In other words, the entire length of the blade insert 59₁ is radially supported and is in contact with the main body 57₁ of the curved elastic leaves 56₁. Also, the free distal end 60 of the elastic leaf 56₁ is defined by free distal ends of both the main body 57₁ and the blade insert 59₁, of the curved elastic leaves 56₁.

At least one of the first and second side plates 46 and 48 of the torsional vibration damper 16 is formed with at least one, and preferably a plurality of viewing windows 49 therethrough, as best shown in FIG. 6. In the exemplary embodiment of the present invention, the first side plate 46 of the torsional vibration damper 16 is formed with four (4) viewing windows 49 therethrough, which are circumferentially and equiangularly spaced from each other around the rotational axis X, as best shown in FIG. 6. As best shown in FIG. 4A, the viewing windows 49 are configured to expose a portion of the radially elastic output member 42 of the torsional vibration damper 16, to allow identification of how the curved elastic blades 56 of the radially elastic output member 42 are angularly oriented, i.e., whether the curved elastic blades 56 extend in the circumferential direction clockwise or counterclockwise around the rotational axis X.

In operation, when a rolling body 50 moves along the raceway 66 of the blade insert 59₁ of the curved elastic leaf 56₁, the rolling body 50 presses the curved raceway portion 64 of the curved elastic leaf 56₁ radially inwardly, thus maintaining contact of the rolling body 50 with the curved raceway portion 64 of the curved elastic leaf 56₁, as best illustrated in FIGS. 3 and 5. Radial forces make it possible for the main body 57₁ of the curved elastic blade 56₁ to bend, and forces tangential to the raceway 66 of the curved elastic leaf 56₁ make it possible for the rolling body 50 to move (roll) on the raceway 66 of the curved elastic leaf 56₁, and to transmit torque from the torque input member 40 to the output hub 44 of the elastic output member 42₁, and then to the driven shaft 2. Thus, the output hub 44 of the radially elastic output member 42₁, which is splined directly to the driven shaft 2, forms an output part of the torsional vibration damper 16 and a driven side of the torque-coupling device 10. The piston member 34, on the other hand, forms an input part of the torsional vibration damper 16. The torque from the driving shaft (or crankshaft) is transmitted to the casing 12 through the flexplate 11 and studs 13.

In the disengaged position of the lock-up clutch 15, the torque flows through the torque converter 14, i.e. the impeller wheel 20 and then the turbine wheel 22 non-rotatably coupled to the to the first side plate 46 of the torque input member 40. The torque is then transmitted to the driven shaft (transmission input shaft) 2 splined directly to the output hub 44. In the engaged position of the lock-up clutch 15, torque from the casing 12 is transmitted to the torque input member 40 (i.e., the first and the second side plates 46 and 48, and the rolling bodies 50) through the elastic output member 42 formed by the output hub 44 and the elastic leaves 56. The torque is then transmitted from the output hub 44 of the elastic output member 42 to the driven shaft (transmission input shaft) 2 splined to the output hub 44. Moreover, when the torque transmitted between the casing 12 and the output hub 44 of the elastic output member 42 varies, the radial forces exerted between each of the elastic leaves 56 and the corresponding rolling bodies 50 vary and bending of the elastic leaves 56 is accordingly modified. The modification in the bending of the elastic leaf 56 comes with motion of the rolling body 50 along the associated raceway 66 of the curved elastic leaf 56 due to stresses.

The raceway 66 has a profile so arranged that, when the transmitted torque increases, the rolling body 50 exerts a bending force on the corresponding curved elastic leaf 56₁ which causes the free distal end 60 of the curved elastic leaf 56₁ to move radially towards the rotational axis X and produces a relative rotation between the torque input member 40 and the output hub 44 of the elastic output member 42, such that both the first and the second side plates 46, 48 and the output hub 44 move away from their relative rest positions. A rest position is that position of the torque input member 40 relative to the elastic output member 42, wherein no torque is transmitted between the casing 12 and the output hub 44 of the elastic output member 42 through the rolling bodies 50.

The profiles of the raceways 66 are such that the rolling bodies 50 exert bending forces (pressure) having radial and circumferential components onto the curved elastic leaves 56. Specifically, the elastic leaves 56 are configured so that in a relative angular position between the torque input member 40 and the elastic output member 42 different from the rest position, each of the rolling bodies 50 exerts a bending force on the corresponding elastic leaf 56, thus causing a reaction force of the elastic leaf 56 acting on the rolling body 50, with the reaction force having a radial component which tends to maintain the elastic leaf 56 in contact with the rolling body 50. In turn, each of the elastic leaves 56 exerts onto the corresponding rolling body 50 a back-moving force having a circumferential component which tends to rotate the rolling bodies 50 in a reverse direction of rotation, and thus to move the torque input member 40 (thus, the turbine wheel 22) and the output hub 44 of the elastic output member 42 back towards their relative rest positions, and a radial component directed radially outwardly, which tends to maintain each of the raceways 66 in direct contact with the corresponding rolling body 50. When the torque input member 40 and the elastic output member 42 are in the rest position, the elastic leaves 56 are preferably radially pre-stressed toward the rotational axis X so as to exert a reaction force directed radially outwards, to thus maintain the curved elastic leaves 56 in engagement with the associated rolling bodies 50.

Moreover, the profiles of the raceways 66 are so arranged that a characteristic transmission curve of the torque according to the angular displacement of the rolling body 50 relative to the raceway 66 is symmetrical or asymmetrical relative to the rest position as may be desired. According to the exemplary embodiment, the angular displacement of the rolling body 50 relative to the raceway 66 is more important in a direct direction of rotation than in a reverse (i.e., opposite to the direct) direction of rotation.

According to the exemplary embodiment, the angular displacement of the casing 12 relative to the elastic output member 42₁ in the locked position of the lock-up clutch 15 is greater than 20°, preferably greater than 40°. The curved elastic leaves 56₁ are regularly distributed around the rotational axis X and are symmetrical relative to the rotational axis X so as to ensure the balance of the torque converter 14.

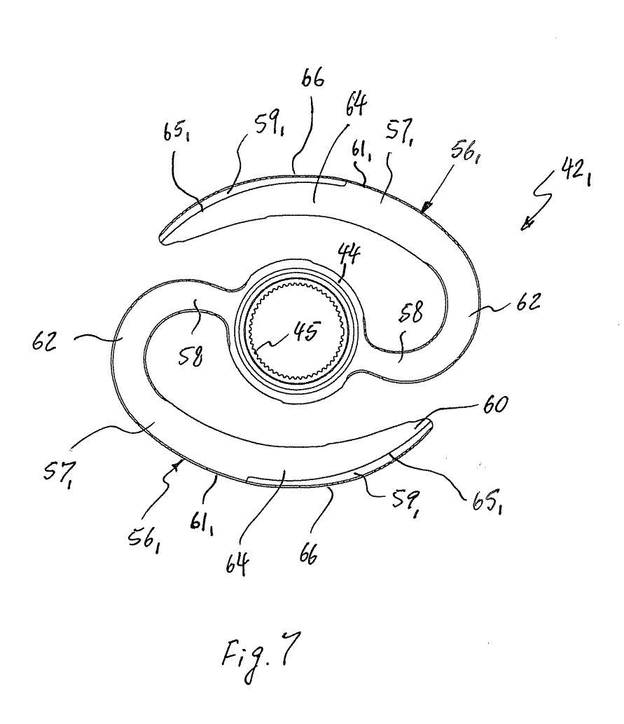

Various modifications, changes, and alterations may be practiced with the above-described embodiment of the elastic output member 42₁, including but not limited to the additional embodiments shown in FIGS. 8-11. In the interest of brevity, reference characters in FIGS. 8-11 that are discussed above in connection with FIGS. 2-7 are not further elaborated upon below, except to the extent necessary or useful to explain the additional embodiments of FIGS. 8-11. Modified components and parts are indicated by the addition of a subscript numeral 2, 3, or 4 to the reference numeral 42 of the elastic output member 42₁.

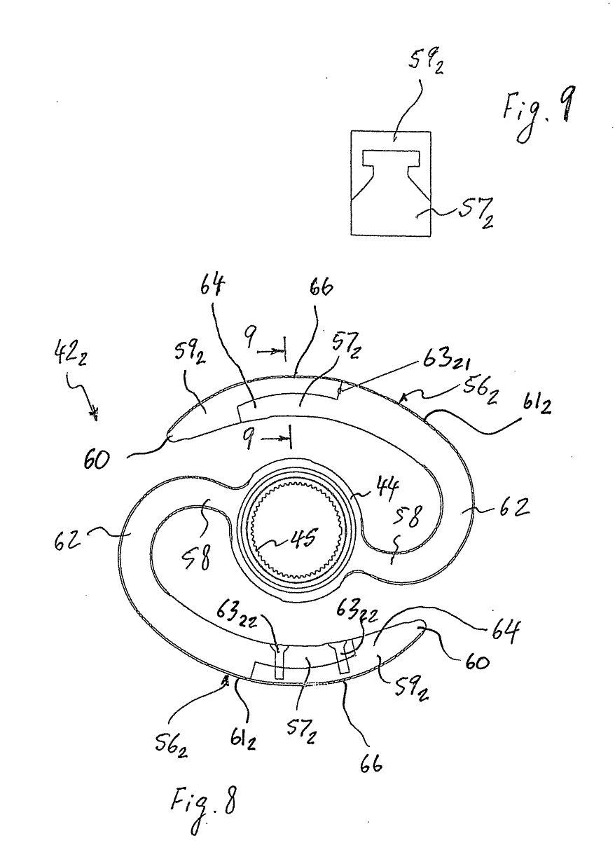

Alternatively, the torsional vibration damper 16 of the hydrokinetic torque-coupling device 10 may comprise an integral radially elastic output member 42₂ according to a second exemplary embodiment thereof illustrated in FIGS. 8 and 9. The elastic output member 42₂ of FIGS. 8 and 9 corresponds substantially to the elastic output member 42₁ of FIGS. 2-7, and portions thereof, which differ, will therefore be explained in detail below.

The radially elastic output member 42₂ includes an annular output hub 44 coaxial with the rotational axis X and rotatable relative the torque input member 40, and at least one and preferably two substantially identical, radially opposite curved elastic leaves (or blades) 56₂ integral (i.e., unitary) with the output hub 44, as best shown in FIG. 8. The output hub 44 of the radially elastic output member 42₂ is axially moveable relative to the driven shaft 2 due to a splined connection therebetween. Accordingly, the radially elastic output member 42₂ is non-rotatably coupled to and axially moveable relative to the driven shaft 2.

As best shown in FIG. 8, each of the curved elastic leaves 56₂ has a proximal end 58 non-moveably connected (i.e., fixed) to the output hub 44, a free, angularly distal end 60, a bent portion 62 adjacent to the proximal end 58, and a curved raceway portion 64 defining a cam profile and disposed adjacent to the free distal end 60 of the elastic leaf 56₂ for bearing one of the rolling bodies 50. Also, the curved raceway portion 64 is connected to the output hub 44 by the bent portion 62. The output member 42₂ with the output hub 44 and the elastic leaves 56₂ is an integral (or unitary) component, e.g., made of a single part, or a part made of separate components fixedly connected together.

Each of the curved elastic leaves 56₂ and each of the raceway portions 64 are elastically deformable. The bent portion 62 subtends an angle of approximately 180°. A portion of a radially external surface of the curved raceway portion 64 of each of the curved elastic leaves 56₂ defines a radially outer raceway 66 configured as a surface that is in a rolling contact with one of the rollers 50, so that each of the rolling bodies 50 is positioned radially outside of the elastic leaf 56₂, as illustrated in FIG. 8. The raceways 66 of the curved raceway portions 64 of the curved elastic leaf 56₂ extend on a circumference and subtend an angle ranging from about 90° to about 180°. The raceway 66 of each of the curved raceway portions 64 has a generally convex shape, as best shown in FIG. 8. Moreover, as the torque input member 40 is axially moveable along the rotational axis X relative to the turbine assembly 22 and the turbine assembly 22, the rolling bodies 50 are axially displaceable relative to the raceways 66 of the curved raceway portions 64 of the curved elastic leaves 56₂.

As best shown in FIG. 8, the curved elastic leaves 56₂ are symmetrical with respect to the rotational axis X. Moreover, each of the curved elastic leaves 56₂ of the radially elastic output member 42₂ includes a main body 57₂ and a blade insert 59₂ non-moveably secured (i.e., fixed) to the main body 57₂ of each of the curved elastic leaves 56₂. The blade insert 59₂ is fixed to the main body 57₂ of each of the curved elastic leaves 56₂ by appropriate means, such as by keyed connection (including a tongue 57₂₁ formed on the main body 57₂, which engages a groove 59₂₁ formed in the blade insert 59₂ as shown in FIG. 9) and welding (such as laser welding 63₂₁) (as shown in upper half of the elastic output member 42₂ in FIG. 8), or mechanical fasteners (e.g., rivets or screws 63₂₂) (as shown in lower half of the elastic output member 42₂ in FIG. 8), adhesive bonding, etc.

The main body 57₂ of each of the curved elastic blades 56₂ is made of flexible (i.e., elastic) material, such as spring steel, carbon fiber or composite polymer material. The blade insert 59₂ of each of the curved elastic blades 56₂, on the other hand, is made of hardened steel, such as tool steel (HRC 45-65), and includes the curved raceway portion 64 defining the cam profile.

The radially outer raceway 66 of each of the curved elastic blades 56₂ is defined by at least a portion of a radially outer surface of the blade insert 59₂ (made of hardened steel) that is in rolling contact with one of the rollers 50. Thus, the rollers 50 each travel on the blade insert 59₂ and do not make contact with the main body 57₂ of the associated curved elastic blade 56₂.

As best shown in FIG. 8, the blade insert 59₂ is in the form of a curved steel part fixed to a distal end portion of the main body 57₂ of the curved elastic leaves 56₂. Furthermore, the radially outer raceway 66 of the blade insert 59₂ is coplanar with a radially outer surface 61₂ of the main body 57₂ adjacent to the radially outer raceway 66 of the curved elastic leaves 56₂. Moreover, the blade insert 59₂ partially overlaps the main body 57₂ of the curved elastic leaves 56₂ in circumferential direction, as further shown in FIG. 8. In other words, a portion of the blade insert 59₂ extends over, and is radially supported and in contact with a portion of the main body 57₂ of the curved elastic leaves 56₂. Also, the free distal end 60 of the elastic leaf 56₂ is defined only by a free distal end of the blade insert 59₂ of the curved elastic leaves 56₂. In other words, the blade insert 59₂ extends circumferentially from an angularly distal end of the main body 57₂ of the curved elastic leaves 56₂.

In operation, when a rolling body 50 moves along the raceway 66 of the blade insert 59₂ of the curved elastic leaf 56₂, the rolling body 50 presses the curved raceway portion 64 of the curved elastic leaf 56₂ radially inwardly, thus maintaining contact of the rolling body 50 with the curved raceway portion 64 of the curved elastic leaf 56₂.

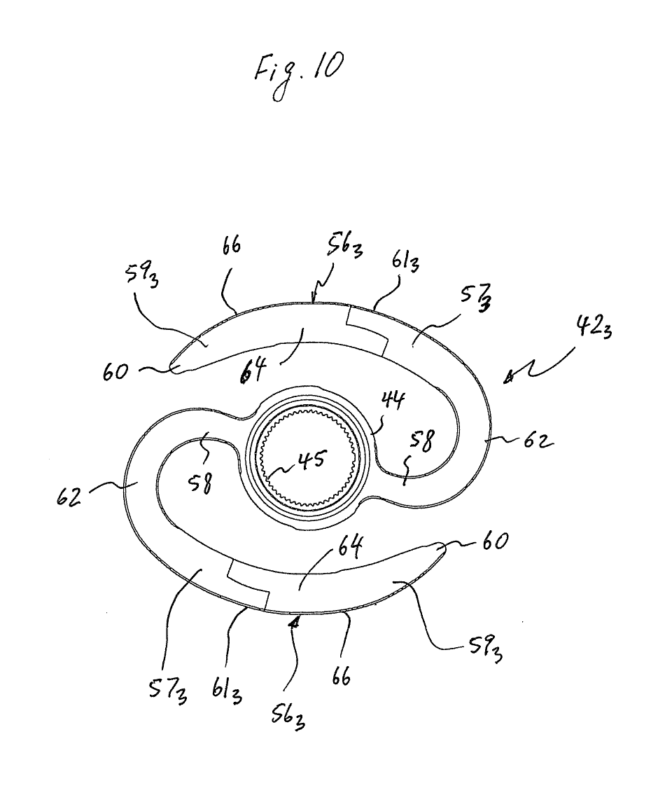

Further alternatively, the torsional vibration damper 16 of the hydrokinetic torque-coupling device 10 may comprise an integral radially elastic output member 42₃ according to a third exemplary embodiment thereof illustrated in FIG. 10. The elastic output member 42₃ of FIG. 10 corresponds substantially to the elastic output member 42₂ of FIGS. 8 and 9, and portions thereof, which differ, will therefore be explained in detail below.

The radially elastic output member 42₃ includes an annular output hub 44 coaxial with the rotational axis X and rotatable relative the torque input member 40, and at least one and preferably two substantially identical, radially opposite curved elastic leaves (or blades) 56₃ integral (i.e., unitary) with the output hub 44, as best shown in FIG. 10. The output hub 44 of the radially elastic output member 42₃ is axially moveable relative to the driven shaft 2 due to a splined connection therebetween. Accordingly, the radially elastic output member 42₃ is non-rotatably coupled to and axially moveable relative to the driven shaft 2.

As best shown in FIG. 10, each of the curved elastic leaves 56₃ has a proximal end 58 non-moveably connected (i.e., fixed) to the output hub 44, a free, angularly distal end 60, a bent portion 62 adjacent to the proximal end 58, and a curved raceway portion 64 defining a cam profile and disposed adjacent to the free distal end 60 of the elastic leaf 56₃ for bearing one of the rolling bodies 50. Also, the curved raceway portion 64 is connected to the output hub 44 by the bent portion 62. The output member 42₃ with the output hub 44 and the elastic leaves 56₃ is an integral (or unitary) component, e.g., made of a single part, but may be separate components fixedly connected together.

Each of the curved elastic leaves 56₃ and each of the raceway portions 64 are elastically deformable. The bent portion 62 subtends an angle of approximately 180°. A portion of a radially external surface of the curved raceway portion 64 of each of the curved elastic leaves 56₃ defines a radially outer raceway 66 configured as a surface that is in a rolling contact with one of the rollers 50, so that each of the rolling bodies 50 is positioned radially outside of the elastic leaf 56₃, as illustrated in FIG. 10. The raceways 66 of the curved raceway portions 64 of the curved elastic leaf 56₃ extend on a circumference and subtend an angle ranging from about 90° to about 180°. The raceway 66 of each of the curved raceway portions 64 has a generally convex shape, as best shown in FIG. 10. Moreover, as the torque input member 40 is axially moveable along the rotational axis X relative to the turbine assembly 22 and the turbine assembly 22, the rolling bodies 50 are axially displaceable relative to the raceways 66 of the curved raceway portions 64 of the curved elastic leaves 56₃.

As best shown in FIG. 10, the curved elastic leaves 56₃ are symmetrical with respect to the rotational axis X. Moreover, each of the curved elastic leaves 56₃ of the radially elastic output member 42₃ includes a main body 57₃ and a blade insert 59₃ non-moveably secured (i.e., fixed) to the main body 57₃ of each of the curved elastic leaves 56₃. The blade insert 59₃ is fixed to the main body 57₃ of each of the curved elastic leaves 56₃ by appropriate means, such as by keyed connection (similar to shown in FIG. 9) and welding (similar to the laser welding 63₂₁ shown in FIG. 9), or mechanical fasteners (e.g., rivets or the screws 63₂₂) (similar to shown in FIG. 8), adhesive bonding, etc.

The main body 57₃ of each of the curved elastic blades 56₃ is made of flexible (i.e., elastic) material, such as spring steel, carbon fiber or composite polymer material. The blade insert 59₃ of each of the curved elastic blades 56₃, on the other hand, is made of hardened steel, such as tool steel (HRC 45-65), and includes the curved raceway portion 64 defining the cam profile.

The radially outer raceway 66 of each of the curved elastic blades 56₃ is defined by at least a portion of a radially outer surface of the blade insert 59₃ (made of hardened steel) that is in rolling contact with one of the rollers 50. Thus, the rollers 50 travel on the blade insert 59₃ and do not make contact with the main body 57₃ of the curved elastic blade 56₃.

As best shown in FIG. 10, the blade insert 59₃ is in the form of a curved steel part fixed to a distal end portion of the main body 57₃ of the curved elastic leaves 56₃. Furthermore, the radially outer raceway 66 of the blade insert 59₃ is coplanar with a radially outer surface 61₃ of the main body 57₃ adjacent to the radially outer raceway 66 of the curved elastic leaves 56₃. Moreover, the main body 57₃ partially overlaps the blade insert 59₃ of the curved elastic leaves 56₃ in circumferential direction, as further shown in FIG. 10. In other words, a portion of the main body 57₃ extends over, and is radially supported and in contact with a portion of the blade insert 59₃ of the curved elastic leaves 56₃. Also, the free distal end 60 of the elastic leaf 56₃ is defined only by a free distal end of the blade insert 59₃ of the curved elastic leaves 56₃. In other words, the blade insert 59₃ extends circumferentially from an angularly distal end of the main body 57₃ of the curved elastic leaves 56₃.

In operation, when a rolling body 50 moves along the raceway 66 of the blade insert 59₃ of the curved elastic leaf 56₃, the rolling body 50 presses the curved raceway portion 64 of the curved elastic leaf 56₃ radially inwardly, thus maintaining contact of the rolling body 50 with the curved raceway portion 64 of the curved elastic leaf 56₃.

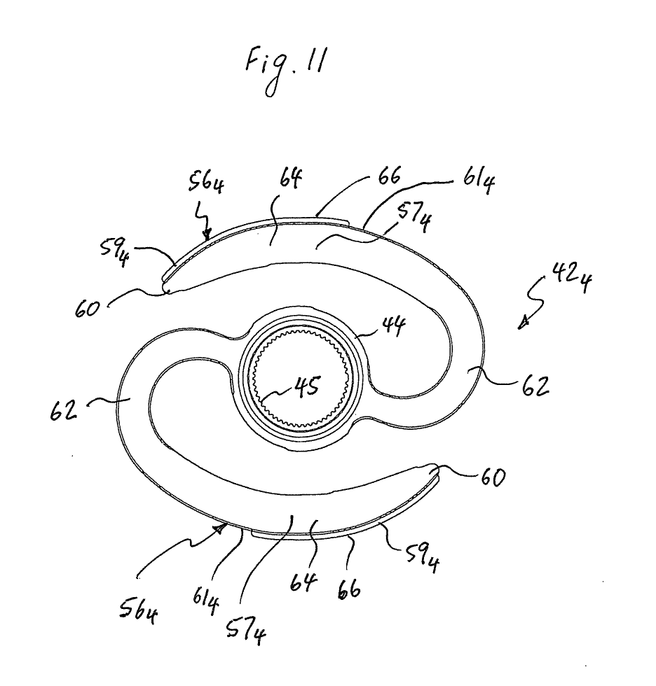

Further alternatively, the torsional vibration damper 16 of the hydrokinetic torque-coupling device 10 may comprise an integral radially elastic output member 42₄ according to a fourth exemplary embodiment thereof illustrated in FIG. 11. The elastic output member 42₄ of FIG. 11 corresponds substantially to the elastic output member 42₁ of FIGS. 2-7, and portions thereof, which differ, will therefore be explained in detail below.

The radially elastic output member 42₄ includes an annular output hub 44 coaxial with the rotational axis X and rotatable relative the torque input member 40, and at least one and preferably two substantially identical, radially opposite curved elastic leaves (or blades) 56₄ integral (i.e., unitary) with the output hub 44, as best shown in FIG. 11. The output hub 44 of the radially elastic output member 42₄ is axially moveable relative to the driven shaft 2 due to a splined connection therebetween. Accordingly, the radially elastic output member 42₄ is non-rotatably coupled to and axially moveable relative to the driven shaft 2.

As best shown in FIG. 11, each of the curved elastic leaves 56₄ has a proximal end 58 non-moveably connected (i.e., fixed) to the output hub 44, a free, angularly distal end 60, a bent portion 62 adjacent to the proximal end 58, and a curved raceway portion 64 defining a cam profile and disposed adjacent to the free distal end 60 of the elastic blade 56₄ for bearing one of the rolling bodies 50. Also, the curved raceway portion 64 is connected to the output hub 44 by the bent portion 62. The output member 42₄ with the output hub 44 and the elastic blades 56₄ is an integral (or unitary) component, e.g., made of a single part, or made of separate components fixedly connected together.

Each of the curved elastic blades 56₄ and each of the raceway portions 64 are elastically deformable. The bent portion 62 subtends an angle of approximately 180°. A portion of a radially external surface of the curved raceway portion 64 of each of the curved elastic blades 56₄ defines a radially outer raceway 66 configured as a surface that is in a rolling contact with one of the rollers 50, so that each of the rolling bodies 50 is positioned radially outside of the elastic blade 56₄, as illustrated in FIG. 11. The raceways 66 of the curved raceway portions 64 of the curved elastic blade 56₄ extend on a circumference and subtend an angle ranging from about 90° to about 180°. The raceway 66 of each of the curved raceway portions 64 has a generally convex shape, as best shown in FIG. 11. Moreover, as the torque input member 40 is axially moveable along the rotational axis X relative to the turbine assembly 22 and the turbine assembly 22, the rolling bodies 50 are axially displaceable relative to the raceways 66 of the curved raceway portions 64 of the curved elastic blades 56₄.

As best shown in FIG. 11, the curved elastic leaves 56₄ are symmetrical with respect to the rotational axis X. Moreover, each of the curved elastic leaves 56₄ of the radially elastic output member 42₄ includes a main body 57₄ and a blade insert 59₄ non-moveably secured (i.e., fixed) to the main body 57₄ of each of the curved elastic leaves 56₄. The blade insert 59₄ is fixed to the main body 57₄ of each of the curved elastic leaves 56₄ by appropriate means, such as mechanical fasteners (e.g., rivets or screws), welding (such as laser welding), adhesive bonding, etc.

As best shown in FIG. 11, the blade insert 59₄ is in the form of a curved steel strip fixed to a radially outer surface of the main body 57₄ of the curved elastic leaves 56₄. Furthermore, the radially outer raceway 66 of the blade insert 59₄ is not coplanar with a radially outer surface 61₄ of the main body 57₄ adjacent to the radially outer raceway 66 of the curved elastic leaves 56₄. Instead, the raceway 66 of the blade insert 59₄ is radially outwardly spaced from the radially outer surface 61₄ of the main body 57₄ adjacent to the raceway 66 of the curved elastic leaves 56₄. Moreover, the main body 57₄ of the curved elastic leaves 56₄ overlaps an entire length of the blade insert 59₄ in the circumferential direction, as further shown in FIG. 11. In other words, the entire length of each blade insert 59₄ is radially supported and is in contact with the main body 57₄ of the associated curved elastic leaf 56₄. Also, the free distal end 60 of the elastic leaf 56₄ is defined by free distal ends of both the main body 57₄ and the blade insert 59₄ of the curved elastic leaves 56₄.

The main body 57₄ of each of the curved elastic blades 56₄ is made of flexible (i.e., elastic) material, such as spring steel, carbon fiber or composite polymer material. The blade insert 59₄ of each of the curved elastic blades 56₄, on the other hand, is made of hardened steel, such as tool steel (HRC 45-65), and includes the curved raceway portion 64 defining the cam profile.

The radially outer raceway 66 of each of the curved elastic blades 56₄ is defined by at least a portion of a radially outer surface of the blade insert 59₄ (made of hardened steel) that is in a rolling contact with one of the rollers 50. Thus, the rollers 50 travel on the blade insert 59₄ and do not make contact with the main body 57₄ of the curved elastic blade 56₄.

In operation, when a rolling body 50 moves along the raceway 66 of the blade insert 59₄ of the curved elastic leaf 56₄, the rolling body 50 presses the curved raceway portion 64 of the curved elastic leaf 56₄ radially inwardly, thus maintaining contact of the rolling body 50 with the curved raceway portion 64 of the curved elastic leaf 56₄.

The radially elastic output members 42₁-42₄ and the curved elastic blades 56₁-56₄, are substantially geometrically identical to each other in the exemplary embodiment of the present invention. In view of these similarities, and in the interest of simplicity, the description of the exemplary embodiments and methods of the invention occasionally uses a reference numeral 42 and 56 without a subscript numeral to designate an entire group of substantially geometrically identical radially elastic output members. For example, the reference numeral 42 will be used when generically referring to each of the radially elastic output members 42₁-42₄ rather than reciting all four reference numerals, while the reference numeral 56 will be used when generically referring to each of the radially elastic output members 56₁-56₄.

The lock-up clutch 15 is provided for locking the driving shaft and the driven shaft 2 together. In other words, the lock-up clutch 15 is configured to non-rotatably couple the casing 12 and the torque input member 40 in the engaged (locked) position, and configured to drivingly disengage the casing 12 and the torque input member 40 in the disengaged (open) position.

The lock-up clutch 15 is usually activated after starting of the motor vehicle and after hydraulic coupling of the driving and driven shafts, in order to avoid the loss of efficiency caused in particular by slip phenomena between the turbine wheel 22 and the impeller wheel 20. The piston member 34 is axially displaceable toward (an engaged (or locked) position of the lock-up clutch 15) and away (a disengaged (or open) position of the lock-up clutch 15) from the locking surface 18 inside the casing 12. Moreover, the piston member 34 is axially displaceable away from and toward the locking surface 18 of the casing 12 together with the torsional vibration damper 16 relative to the driven shaft 2 along the rotational axis X. The sealing member (e.g., the sealing ring) 72 creates a seal at the interface of the cylindrical flange 48if of the second side plate 48 and the driven shaft 2.

The axial motion of the piston member 34 and the torsional vibration damper 16 along the driven shaft 2 is controlled by a pressure differential between the torus and damper pressure chambers 23₁ and 23₂ positioned on axially opposite sides of the torsional vibration damper 16.

The piston member 34 is selectively pressed against the locking surface 18 of the casing 12 so as to lock-up the torque-coupling device 10 between the driving shaft and the driven shaft 2 to control sliding movement between the turbine wheel 22 and the impeller wheel 20. As discussed above, the torque input member 40 of the torsional vibration damper 16 with the piston member 34 is axially movable toward and away from the locking surface 18 of the casing 12 between the lockup position and the non-lockup (open) position. Axial movement of the torque input member 40 is accomplished by changing the pressure differential between the torus and damper pressure chambers 23₁ and 23₂. A pressure increase in the torus chamber 23₁ relative to the damper chamber 23₂ (or stated differently, a pressure decrease in the damper chamber 23₂ relative to the torus chamber 23₁) shifts the torsional vibration damper 16 and the piston member 34 axially in the direction of torque transmission, i.e., towards the locking surface 18 of the casing 12, that is left to right in FIG. 2, into the lockup position.

Specifically, when the pressure in the torus chamber 23₁ increases relative to the damper chamber 23₂, the hydraulic fluid from the torus chamber 23₁ flows under pressure into the cavity between the first and second side plates 46 and 48 of the torsional vibration damper 16 through the coupling openings 32 in the turbine shell 28 of the turbine wheel 22 and the first and second communication openings 55₁ and 55₂ in the first side plate 46. As a result, the hydraulic fluid from the torus chamber 23₁ presses the second side plate 48 in the direction away from the turbine wheel 22 so as to displace the torsional vibration damper 16 with the piston member 34 towards the locking surface 18 of the casing 12. In other words, when an appropriate hydraulic pressure in applied to the torque input member 40 of the torsional vibration damper 16, the torsional vibration damper 16 with the piston member 34 moves rightward (as shown in FIG. 2) toward the locking surface 18 of the casing 12 and away from the turbine wheel 22, and clamps (engages) the friction liner 35 between itself and the locking surface 18 of the casing 12. As a result, the lock-up clutch 15 in the locked position is mechanically frictionally coupled to the casing 12 so as to bypass the turbine wheel 22 when in the locked position of the lock-up clutch 15. Thus, the lock-up clutch 15 is provided to bypass the turbine wheel 22 when in the locked position thereof.

On the other hand, a pressure increase in the damper chamber 23₂ relative to the torus chamber 23₁ (or stated differently a pressure decrease in the torus chamber 23₁ relative to the damper chamber 23₂) shifts the torsional vibration damper 16 and the piston 34 affixed thereto axially against the direction of torque transmission, i.e., away from the locking surface 18 of the casing 12, that is right to left in FIG. 2, out of the lockup position. Pressure changes are created by control of the fluid, e.g., hydraulic fluid or oil, in the chambers 23₁ and 23₂. Specifically, when the pressure in the damper chamber 23₂ increases relative to the torus chamber 23₁, the hydraulic fluid in the damper chamber 23₂ presses the second side plate 48 in the direction toward the turbine wheel 22 so as to displace the torsional vibration damper 16 with the piston member 34 away from the locking surface 18 of the casing 12. In other words, when an appropriate hydraulic pressure in applied to the torque input member 40 of the torsional vibration damper 16, the torsional vibration damper 16 with the piston member 34 moves leftward (as shown in FIG. 2) toward the turbine wheel 22 and away from the locking surface 18 of the casing 12, and disengages the friction liner 35 from the locking surface 18 of the casing 12. As a result, the lock-up clutch 15 in the disengaged position mechanically frictionally uncouples the torsional vibration damper 16 from the casing 12 so that the turbine wheel 22 is hydro-dynamically rotationally drivable by the impeller wheel 20. Thus, in the non-lockup mode, torque is transferred from the engine to the casing 12, then from the impeller wheel 20 hydro-dynamically to the turbine wheel 22, then the torsional vibration damper 16, and from the output hub 44 of the torsional vibration damper 16 directly to the driven shaft 2.

During operation, when the lock-up clutch 15 is in the disengaged (open) position, the engine torque is transmitted from the impeller wheel 20 by the turbine wheel 22 of the torque converter 14 to the driven shaft 2 through the torsional vibration damper 16. When the lock-up clutch 15 is in the engaged (locked) position, the engine torque is transmitted by the casing 12 to the driven shaft 2 also through the torsional vibration damper 16.

A method for assembling the hydrokinetic torque-coupling device 10 is as follows. It should be understood that this exemplary method may be practiced in connection with the other embodiments described herein. This exemplary method is not the exclusive method for assembling the turbine assembly described herein. While the methods for assembling the hydrokinetic torque-coupling device 10 may be practiced by sequentially performing the steps as set forth below, it should be understood that the methods may involve performing the steps in different sequences.

The method for assembling the hydrokinetic torque-coupling device 10 is as follows. First, the impeller wheel 20, the turbine wheel 22, the stator 24, and the torsional vibration damper 16 may each be preassembled. The impeller wheel 20 and the turbine wheel 22 are formed by stamping from steel blanks or by injection molding of a polymeric material. The turbine shell 28 of the turbine wheel 22 is formed with at least one, preferably a plurality of coupling openings 32 therethrough and circumferentially spaced from each other. The stator 24 is made by casting from aluminum or injection molding of a polymeric material. The impeller wheel 20, the turbine wheel 22 and the stator 24 subassemblies are assembled together so as to form the torque converter 14.

The torsional vibration damper 16 is then added. The first side plate 46 with the coupling arms 47 and the first and second communication openings 55₁ and 55₂ is formed by stamping from a steel blank. The second side plate 48 is also formed by stamping from a steel blank. Before the torsional vibration damper 16 is assembled, the piston member 34 of the lock-up clutch 15 is fixed (i.e., non-movably secured) to the first side plate 46 of the torque input member 40 by appropriate means, such as by welding, adhesive bonding or fasteners, such as rivets. Next, the torsional vibration damper 16 is mounted to the turbine wheel 22 so that the turbine shell 28 non-rotatably engages the first side plate 46 of the torque input member 40 of the torsional vibration damper 16. Specifically, the coupling arms 47 of the first side plate 46 engage the coupling openings 32 of the turbine shell 28.

The elastic output member 42 is formed with the output hub 44 and at least one and preferably two substantially identical, radially opposite curved elastic blades 56 as an integral (or unitary) component, e.g., made as a single part, but may be made of separate components fixedly connected together. The elastic output member 42 includes a main body 57 and a blade insert 59 non-moveably secured (i.e., fixed) to the main body 57 of each of the curved elastic leaves 56. The blade insert 59 is fixed to the main body 57 of each of the curved elastic leaves 56 by appropriate means, such as mechanical fasteners (e.g., rivets or screws), welding (such as laser welding), adhesive bonding, etc. The main body 57 of each of the curved elastic blades 56 is made of flexible material, such as spring steel, carbon fiber or composite polymer material. The blade insert 59 of each of the curved elastic blades 56, on the other hand, is made of hardened steel, such as tool steel (HRC 45-65). The term “tool steel” commonly refers to a variety of carbon and alloy steels that are particularly well-suited to be made into tools. Their suitability comes from their distinctive hardness, resistance to abrasion and deformation and their ability to hold a cutting edge at elevated temperatures. As a result, tool steels are suited for their use in the shaping of other materials.

Then, the first shell 17₁ is non-moveably and sealingly secured, such as by welding at 19, to the second shell 17₂, as best shown in FIG. 2. After that, the torque-coupling device 10 is mounted to the driven shaft 2 (i.e., the input shaft of the automatic transmission of the motor vehicle) so that the output hub 44 of the elastic output member 42 of the torsional vibration damper 16 is splined directly to the transmission input shaft 2 and the cylindrical flanges 46if and 48if of torque input member 40 of the torsional vibration damper 16 are slidably mounted over the transmission input shaft 2. Various modifications, changes, and alterations may be practiced with the above-described embodiment.

Therefore, the torsional vibration damper of the hydrokinetic torque-coupling device of the present invention provides a number of advantages over the conventional torsional vibration damper. Specifically, the torsional vibration damper of the hydrokinetic torque-coupling device of the present invention simplifies the design, makes assembly of the hydrokinetic torque-coupling device easier, and saves both weight and manufacturing cost of the hydrokinetic torque-coupling device. Moreover, the radially elastic output member of the present invention improves performance, mechanical characteristics and durability of the torsional vibration damper.

The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A torsional vibration damper, comprising:
a torque input member rotatable about a rotational axis and including a radially oriented first side plate and at least one supporting member mounted thereto; and
a unitary radially elastic output member pivotable relative to and elastically coupled to the torque input member;
the radially elastic output member including an output hub coaxial with the rotational axis and rotatable relative the torque input member, and at least one elastic blade non-movably connected to the output hub and configured to elastically and radially engage the at least one supporting member and to elastically bend in the radial direction upon rotation of the first side plate with respect to the radially elastic output member;
the at least one elastic blade defining a raceway configured to bear the at least one supporting member;
the at least one elastic blade including a main body and a blade insert non-moveably secured to the main body and radially engaging the at least one supporting member;
the raceway of the at least one elastic blade defined by at least a portion of a surface of the blade insert.

2. The torsional vibration damper as defined in claim 1, wherein the main body is made of a first material and the blade insert is made of a different second material.

3. The torsional vibration damper as defined in claim 2, wherein the first material of the main body and the second material of the blade insert of the at least one elastic blade have different mechanical properties.

4. The torsional vibration damper as defined in claim 2, wherein the first material of the main body has greater resiliency than the second material of the blade insert, and wherein the second material of the blade insert has higher hardness than the first material of the main body.

5. The torsional vibration damper as defined in claim 1, wherein the at least one supporting member includes at least one support pin extending axially from the first retainer plate and at least one annular rolling body coaxially mounted on the at least one support pin for rotation around a central axis thereof.

6. The torsional vibration damper as defined in claim 1, wherein the torque input member further includes a radially oriented second side plate, which is axially spaced from and non-moveably attached to the first side plate.

7. The torsional vibration damper as defined in claim 1, wherein the first side plate of the torque input member of the torsional vibration damper has at least one viewing window therethrough configured to expose a portion of the radially elastic output member of the torsional vibration damper therethrough and to identify angular orientation of the elastic blades of the radially elastic output member around the rotational axis.

8. The torsional vibration damper as defined in claim 1, wherein the raceway of the blade insert is coplanar with a radially outer surface of the main body adjacent to the raceway of the at least one elastic blade.

9. The torsional vibration damper as defined in claim 1, wherein the raceway of the blade insert is radially outwardly spaced from a radially outer surface of the main body adjacent to the raceway of the at least one elastic blade.

10. The torsional vibration damper as defined in claim 1, wherein the radially elastic output member, including the output hub and the at least one elastic blade, is made as a single-piece part.

11. A hydrokinetic torque-coupling device for coupling a driving shaft and a driven shaft together, comprising:
a casing rotatable about a rotational axis and having a locking surface;
a torque converter including an impeller wheel rotatable about the rotational axis and a turbine wheel disposed in the casing coaxially with the rotational axis, the turbine wheel disposed axially opposite to the impeller wheel and hydro-dynamically rotationally drivable by the impeller wheel; and
a locking piston axially moveable along the rotational axis to and from the locking surface of the casing, the locking piston having an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing;
the locking piston including a torsional vibration damper comprising
a torque input member including a radially oriented first side plate and at least one supporting member mounted thereto; and
a unitary radially elastic output member pivotable relative to and elastically coupled to the torque input member;
the radially elastic output member including an output hub coaxial with the rotational axis and rotatable relative the torque input member, and at least one elastic blade non-movably connected to the output hub and configured to elastically and radially engage the at least one supporting member and to elastically bend in the radial direction upon rotation of the first side plate with respect to the radially elastic output member;
the at least one elastic blade defining a raceway configured to bear the at least one supporting member;
the at least one elastic blade including a main body and a blade insert non-moveably secured to the main body of the at least one elastic blade and radially engaging the at least one supporting member;
the raceway of the at least one elastic blade defined by at least a portion of a surface of the blade insert.

12. The hydrokinetic torque-coupling device as defined in claim 11, wherein the main body is made of a first material and the blade insert is made of a different second material.

13. The hydrokinetic torque-coupling device as defined in claim 12, wherein the first material of the main body and the second material of the blade insert of the at least one elastic blade have different mechanical properties.

14. The hydrokinetic torque-coupling device as defined in claim 12, wherein the first material of the main body has greater resiliency than the second material of the blade insert, and wherein the second material of the blade insert has higher hardness than the first material of the main body.

15. The hydrokinetic torque-coupling device as defined in claim 11, wherein the raceway of the blade insert is coplanar with a radially outer surface of the main body adjacent to the raceway of the at least one elastic blade.

16. The hydrokinetic torque-coupling device as defined in claim 11, wherein the raceway of the blade insert is radially outwardly spaced from a radially outer surface of the main body adjacent to the raceway of the at least one elastic blade.

17. The hydrokinetic torque-coupling device as defined in claim 11, wherein the first side plate of the torque input member of the torsional vibration damper non-rotatably engages the turbine wheel.

18. The hydrokinetic torque-coupling device as defined in claim 11, wherein the torque input member is axially moveable relative to both the impeller wheel and turbine wheel to and from the locking surface of the casing.

19. The hydrokinetic torque-coupling device as defined in claim 11, wherein the locking piston further includes a piston member having the engagement surface, and wherein the piston member is non-moveably connected to the torque input member of the torsional vibration damper.

20. The hydrokinetic torque-coupling device as defined in claim 19, wherein the torque input member further includes a radially oriented second side plate, which is axially spaced from and non-moveably attached to the first side plate, and wherein the piston member is non-moveably connected to the second side plate of the torque input member of the torsional vibration damper.

21. The hydrokinetic torque-coupling device as defined in claim 11, wherein the torque input member further includes a radially oriented second side plate, which is axially spaced from and non-moveably attached to the first side plate.

22. The hydrokinetic torque-coupling device as defined in claim 11, wherein the radially elastic output member, including the output hub and the at least one elastic blade, is made as a single-piece part.

23. A radially elastic output member for a torsional vibration damper, the radially elastic output member being rotatable about a rotational axis and comprising:
an output hub rotatable relative to the rotational axis; and
two elastic blades extending from the output hub;
each of the elastic blades being non-movably connected to the output hub;
each of the elastic blades including a main body and a blade insert non-moveably secured to the main body;
at least a portion of a surface of each blade insert defining a raceway.

24. The radially elastic output member as defined in claim 23, wherein the main body of each of the elastic blades is made of a first material and the blade insert is made of a different second material.

25. The radially elastic output member as defined in claim 23, wherein the output hub includes radially inner splines for operably interconnecting the radially elastic output member with the torsional vibration damper.

26. The radially elastic output member as defined in claim 24, wherein the first material is selected from the group consisting of spring steel, carbon fiber, and composite polymer materials.

27. The radially elastic output member as defined in claim 24, wherein the second material is made of hardened steel having hardness of between HRC 45 to HRC 65.

28. The radially elastic output member as defined in claim 23, wherein the radially elastic output member, including the output hub and the at least one elastic blade, is made as a single-piece part.

29. A method for assembling a torsional vibration damper, the method comprising the steps of:
providing a radially oriented first side plate and at least one supporting member;
rotatably mounting the at least one supporting member to the first side plate;
providing a unitary radially elastic output member, the radially elastic output member including an output hub coaxial with the rotational axis and rotatable relative the torque input member, and at least one elastic blade non-movably connected to the output hub and configured to elastically and radially engage the at least one supporting member and to elastically bend in the radial direction upon rotation of the first side plate with respect to the radially elastic output member; and
elastically coupling the elastic output member to the torque input member so that the at least one elastic blade elastically and radially engages the at least one supporting member;
the at least one elastic blade defining a raceway configured to bear the at least one supporting member;
the at least one elastic blade including a main body and a blade insert non-moveably secured to the main body and radially engaging the at least one supporting member.
